(19) United States
(12) Patent Application Publication
(10) Pub. No.: US 2011/0227924 A1
(43) Pub. Date: Sep. 22, 2011

(54) 3D MODELING APPARATUS, 3D MODELING METHOD, AND COMPUTER READABLE MEDIUM

(75) Inventors: Mitsuyasu NAKAJIMA, Tokyo (JP); Keiichi Sakurai, Tokyo (JP); Takashi Yamaya, Tokyo (JP); Yuki Yoshihama, Tokyo (JP)

(73) Assignee: CASIO COMPUTER CO., LTD., Tokyo (JP)

(21) Appl. No.: 13/049,184

(22) Filed: Mar. 16, 2011

(30) Foreign Application Priority Data
Mar. 17, 2010 (JP) 2010-060115

(51) Int. Cl. G06T 17/00

(52) U.S. Cl. 345/427

(57) ABSTRACT

A 3D modeling apparatus includes: an accepting unit configured to accept sets of images; a generator configured to generate 3D models of a subject based on the sets of images; a selector configured to select first and second 3D models from the 3D models, wherein the second 3D model is to be superimposed on the first 3D model; a divider configured to divide the second 3D model into second regions; a specifying unit configured to specify first regions in the first 3D model, wherein each of the first regions corresponds to one of the second regions; an acquiring unit configured to acquire coordinate transformation parameters; a transformation unit configured to transform coordinates of the second regions based on the coordinate transformation parameters; and an updating unit configured to superimpose the second regions having the transformed coordinates on the first regions to update the first 3D model.

### CROSS-REFERENCE TO RELATED APPLICATION

This application claims priority from Japanese Patent Application No. 2010-060115, filed on Mar. 17, 2010, the entire contents of which are hereby incorporated by reference.

### BACKGROUND

### Technical Field

The present disclosure relates to a 3D modeling apparatus, a 3D modeling method, and a computer readable medium.

There has been known a technique for generating a 3D model of a subject such as a human, an animal or an art object. According to the technique, a pair of images of the subject are taken by use of a stereo camera, and a 3D model of the subject is generated based on the thus taken pair of images.

One 3D model is generated from a pair of images obtained in one shot by the stereo camera. Accordingly, a plurality of 3D models are generated from a plurality of pairs of images obtained by imaging the subject at different angles in a plurality of shots by the stereo camera. When the generated 3D models are combined, a proper 3D model of the subject can be obtained.

However, a part of the subject may move among the shots by the stereo camera. In this case, generated 3D models cannot be combined properly. That is, 3D models of a subject can be combined only when the subject stands still. For this reason, there has been a demand for an image processing apparatus which can perform 3D-modeling on a subject based on a plurality of pairs of images obtained by imaging the subject which is moving partially.

### SUMMARY OF THE INVENTION

Exemplary embodiments of the present invention address the above disadvantages and other disadvantages not described above. However, the present invention is not required to overcome the disadvantages described above, and thus, an exemplary embodiment of the present invention may not overcome any of the disadvantages described above.

Accordingly, it is an illustrative aspect of the present invention to provide a 3D modeling apparatus, a 3D modeling method and a computer readable medium causing a computer to perform a 3D modeling on a subject.

According to one or more illustrative aspects of the present invention, there is provided a 3D modeling apparatus. The apparatus includes: an accepting unit configured to accept a plurality of sets of images that are obtained by capturing a subject at different angles using a stereo camera; a generator configured to generate a plurality of 3D models of the subject based on the sets of images, wherein each of the 3D models corresponds to one of the sets of images; a selector configured to select a first 3D model and a second 3D model from the plurality of 3D models, wherein the second 3D model is to be superimposed on the first 3D model; a divider configured to divide the second 3D model into a plurality of second regions; a specifying unit configured to specify a plurality of first regions in the first 3D model, wherein each of the first regions corresponds to one of the second regions; an acquiring unit configured to acquire a plurality of coordinate transformation parameters for superimposing each of the second regions on the corresponding first region; a transformation unit configured to transform coordinates of the second regions based on the coordinate transformation parameters; and an updating unit configured to superimpose the second regions having the transformed coordinates on the first regions so as to update the first 3D model.

According to one or more illustrative aspects of the present invention, there is provided a 3D modeling method. The method includes: (a) capturing a subject at different angles using a stereo camera so as to obtain a plurality of sets of images; (b) generating a plurality of 3D models of the subject based on the sets of images, wherein each of the 3D models corresponds to one of the sets of images; (c) selecting a first 3D model and a second 3D model from the plurality of 3D models, wherein the second 3D model is to be superimposed on the first 3D model; (d) dividing the second 3D model into a plurality of second regions; (e) specifying a plurality of first regions in the first 3D model, wherein each of the first regions corresponds to one of the second regions; (f) acquiring a plurality of coordinate transformation parameters for superimposing each of the second regions on the corresponding first region; (g) transforming coordinates of the second regions based on the coordinate transformation parameters; and (h) superimposing the second regions having the transformed coordinates on the first regions so as to update the first 3D model.

According to one or more illustrative aspects of the present invention, there is provided a computer-readable medium storing a program for causing the computer to perform following operations. The operations include: (a) capturing a subject at different angles using a stereo camera so as to obtain a plurality of sets of images; (b) generating a plurality of 3D models of the subject based on the sets of images, wherein each of the 3D models corresponds to one of the sets of images; (c) selecting a first 3D model and a second 3D model from the plurality of 3D models, wherein the second 3D model is to be superimposed on the first 3D model; (d) dividing the second 3D model into a plurality of second regions; (e) specifying a plurality of first regions in the first 3D model, wherein each of the first regions corresponds to one of the second regions; (f) acquiring a plurality of coordinate transformation parameters for superimposing each of the second regions on the corresponding first region; (g) transforming coordinates of the second regions based on the coordinate transformation parameters; and (h) superimposing the second regions having the transformed coordinates on the first regions so as to update the first 3D model.

Other aspects and advantages of the present invention will be apparent from the following description, the drawings and the claims.

### BRIEF DESCRIPTION OF THE DRAWINGS

Exemplary embodiments of the present invention will be described in detail based on the following figures, wherein:

FIG. 1A is an external view showing the appearance of a front surface of a stereo camera according to a first embodiment of the invention;

FIG. 1B is an external view showing the appearance of a back surface of the stereo camera according to the first embodiment of the invention;

FIG. 2 is a block diagram showing the configuration of the stereo camera according to the first embodiment of the invention;

FIG. 3 is a block diagram showing the configuration of a main portion of the stereo camera according to the first embodiment of the invention;

FIGS. 4A to 4C are views for explaining a method for imaging a subject by use of the stereo camera;

FIG. 5 is a flow chart showing a 3D modeling process executed by the stereo camera according to the first embodiment of the invention;

FIG. 6 is a flow chart showing a region division process shown in FIG. 5;

FIGS. 7A to 7C are views for explaining a method for dividing a combining 3D model into a plurality of combining regions;

FIG. 7D is a view showing the state where a combined 3D model has been divided into a plurality of combined regions;

FIG. 7E is a view for explaining a method for transforming the coordinates of a combined region;

FIG. 7F is a view showing the state where a combining region has been superimposed on the combined region;

FIG. 7G is a view for explaining a modeling surface after the combination; and

FIG. 8 is a flow chart showing a 3D model combining process shown in FIG. 5.

### DETAILED DESCRIPTION OF EXEMPLARY EMBODIMENTS

3D modeling apparatuses according to embodiments of the invention will be described below with reference to the drawings.

### First Embodiment

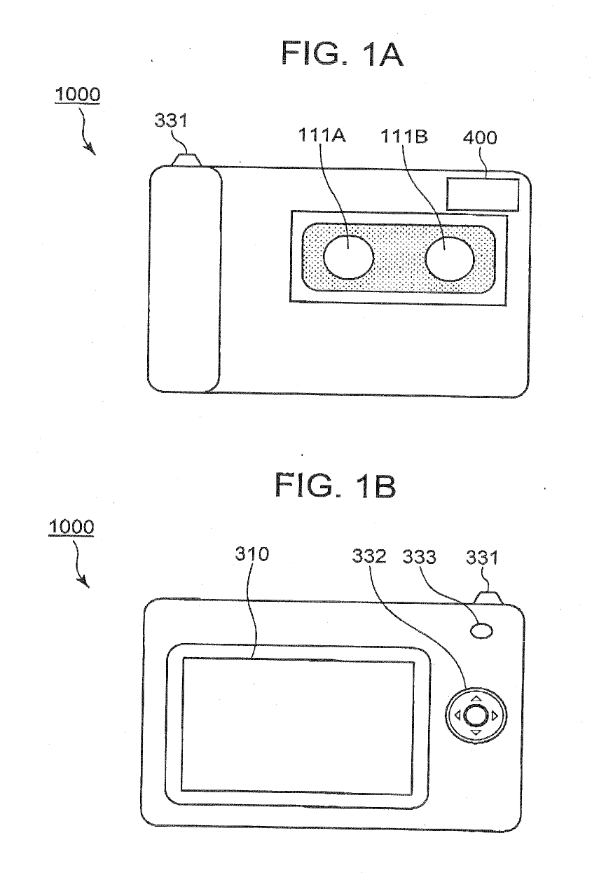

A first embodiment shows an example in which the invention is applied to a digital stereo camera. In the embodiment, the stereo camera executes a process for taking images of a subject and a process for updating a 3D model of the subject repeatedly from when a shutter button is pressed till when the shutter button is pressed again. First, the external appearance of a stereo camera 1000 according to the first embodiment of the invention will be described with reference to FIGS. 1A and 1B.

As shown in FIG. 1A, a lens 111A, a lens 111B and a stroboscopic light emission unit 400 are provided in a front surface of the stereo camera 1000. In addition, as shown in FIG. 1A, a shutter button 331 is provided in a top surface of the stereo camera 1000. Further, as shown in FIG. 1B, a display unit 310, an operation button 332 and a power button 333 are provided in a back surface of the stereo camera 1000.

The lens 111A and the lens 111B are provided at a predetermined distance from each other and in parallel to each other.

The display unit 310 is constituted by an LCD (Liquid Crystal Display) serving as a power button, an operation button and an electronic view finder.

The shutter button 331 is a button which should be pressed to start taking images of a subject or to end taking images of the subject. That is, the stereo camera 1000 takes images of the subject repeatedly after the shutter button 331 is pressed till the shutter button 331 is pressed again.

The operation button 332 accepts various operations from a user. The operation button 332 includes a cross key and a decision key for use in operation for mode switching, display switching, or the like.

The power button 333 is a key which should be pressed for powering on/off the stereo camera 1000.

The stroboscopic light emission unit 400 irradiates the subject with stroboscopic light. The configuration of the stroboscopic light emission unit 400 will be described later.

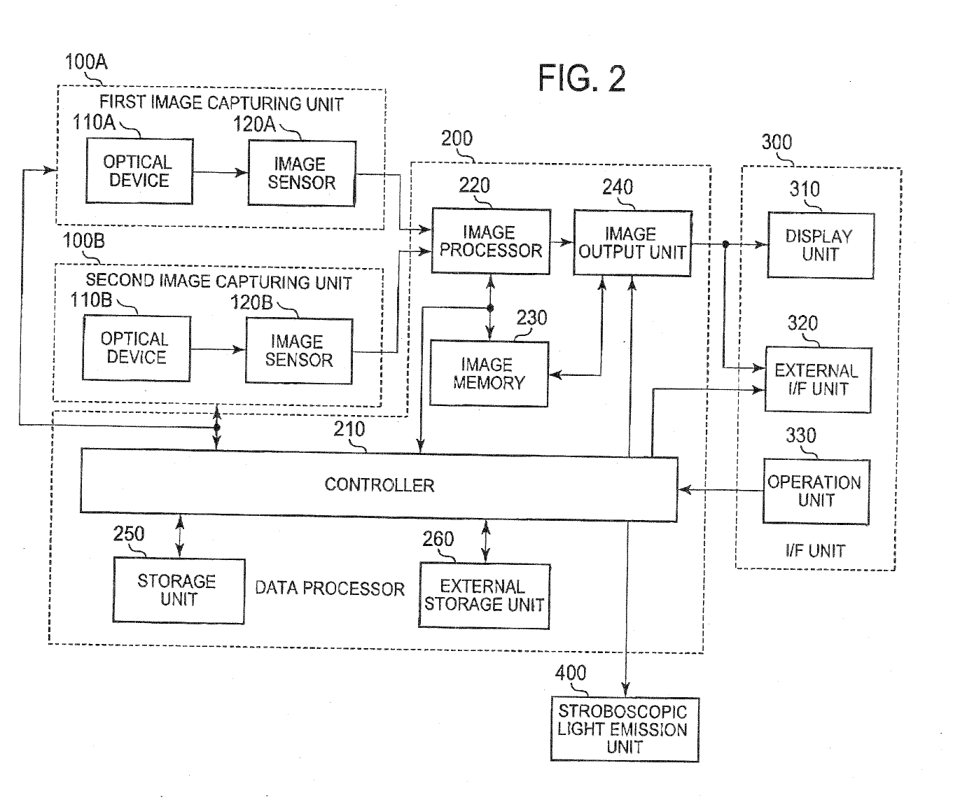

Here, the electric configuration of the stereo camera 1000 will be described with reference to FIG. 2.

As shown in FIG. 2, the stereo camera 1000 is provided with a first image capturing unit 100A, a second image capturing unit 100B, a data processor 200, an interface unit 300 and the stroboscopic light emission unit 400. In FIG. 2, the interface unit is notated as an I/F unit appropriately.

The first image capturing unit 100A and the second image capturing unit 100B are units for capturing images of the subject. The stereo camera 1000 is configured to have two image capturing units, that is, the first image capturing unit 100A and the second image capturing unit 100B in order to serve as a stereo camera. The first image capturing unit 100A and the second image capturing unit 100B have one and the same configuration. Each constituent part of the first image capturing unit 100A is referred to by a numeral with a suffix “A”, while each constituent part of the second image capturing unit 100B is referred to by a numeral with a suffix “B”.

As shown in FIG. 2, the first image capturing unit 100A is provided with an optical device 110A and an image sensor 120A, while the second image capturing unit 100B is provided with an optical device 110B and an image sensor 120B. The optical device 110E has the same configuration as the optical device 110A, and the image sensor 120B has the same configuration as the image sensor 120A. Therefore, description will be made below only on the configurations of the optical device 110A and the image sensor 120A.

The optical device 110A, for example, includes the lens 111A, a diaphragm mechanism, a shutter mechanism, etc. and performs optical operation concerned with imaging. That is, the optical device 110A operates to collect incident light while adjusting optical elements relating to angle of view, focusing, exposure, etc., such as focal length, aperture, shutter speed, and so on. The shutter mechanism included in the optical device 110A is a so-called mechanical shutter. When shutter operation is achieved only by the operation of the image sensor 120A, the shutter mechanism does not have to be included in the optical device 110A. The optical device 110A operates under the control of a controller 210 which will be described later.

The image sensor 120A generates an electric signal in accordance with the incident light collected by the optical device 110A. For example, the image sensor 120A includes an image sensor such as a CCD (Charge Coupled Device) or a CMOS (Complementally Metal Oxide Semiconductor). The image sensor 120A performs photoelectric conversion to generate an electric signal in accordance with the received light, and supplies the electric signal to the data processor 200.

As described above, the first image capturing unit 100A and the second image capturing unit 100B have the same configuration. Accordingly, the first image capturing unit 100A and the second image capturing unit 100B have thoroughly the same specifications including lens' focal length f, lens' F-number, aperture mechanism's aperture range, image sensor's size, image sensor's pixel number, layout, pixel area, etc.

In the stereo camera 1000 having the first image capturing unit 100A and the second image capturing unit 100B configured thus, the lens 111A built in the optical device 110A and the lens 111B built in the optical device 110B are configured to be formed on one and the same plane in the outer surface of the stereo camera 1000 as shown in FIG. 1A. Here, assume that the two lenses (light receiving units) are placed so that their centers are located on one and the same line extending horizontally when the stereo camera 1000 is placed horizontally so that the shutter button 331 is located at the top of the stereo camera 1000. That is, when the first image capturing unit 100A and the second image capturing unit 100B are operated concurrently, two images (hereinafter referred to as “paired images” accordingly) of one and the same subject are taken, but the optical axis positions of the images are laterally shifted from each other. The stereo camera 1000 has a configuration as a so-called parallel stereo camera.

The data processor 200 processes electric signals generated by the imaging operation of the first image capturing unit 100A and the second image capturing unit 100B, so as to generate digital data indicating the taken images of the subject and perform image processing or the like on the images. As shown in FIG. 2, the data processor 200 is constituted by a controller 210, an image processor 220, an image memory 230, an image output unit 240, a storage unit 250, an external storage unit 260, etc.

The controller 210 is, for example, constituted by a processor such as a CPU (Central Processing Unit), a main storage unit such as a RAM (Random Access Memory), etc. The controller 210 executes programs stored in the storage unit 250, which will be described later, or the like, so as to control each unit of the stereo camera 1000.

The image processor 220 is, for example, constituted by an ADC (Analog-Digital Converter), a buffer memory, an image processing processor (so-called image processing engine), etc. The image processor 220 generates digital data (hereinafter referred to as “image data” accordingly) indicating the taken images of the subject based on the electric signals generated by the image sensors 120A and 120B.

That is, the ADC converts the analog electric signals supplied from the image sensor 120A and the image sensor 120B into digital signals, and stores the digital signals into the buffer memory sequentially. On the other hand, the image processor 220 performs a so-called development process or the like on the buffered digital data so as to perform image quality adjustment, data compression, etc.

The image memory 230 is, for example, constituted by a storage unit such as an RAM or a flash memory. The image memory 230 temporarily stores image data generated by the image processor 220, image data to be processed by the controller 210, and so on.

The image output unit 240 is, for example, constituted by an RGB signal generating circuit or the like. The image output unit 240 converts image data stored on the image memory 230 into RGB signals and supplies the ROB signals to a display screen (for example, the display unit 310 which will be described later).

The storage unit 250 is, for example, constituted by a storage unit such as a ROM (Read Only Memory) or a flash memory. The storage unit 250 stores programs, data, etc. required for the operation of the stereo camera 1000. In this embodiment, assume that operation programs executed by the controller 210 and so on, and parameters, operational expressions, etc. required for each processing are stored in the storage unit 250.

The external storage unit 260 is, for example, constituted by a storage unit removably attached to the stereo camera 1000, such as a memory card. The external storage unit 260 stores image data taken by the stereo camera 1000, data expressing a 3D model, etc.

The interface unit 300 has a configuration relating to an interface between the stereo camera 1000 and a user thereof or an external device. As shown in FIG. 2, the interface unit 300 is constituted by the display unit 310, an external interface unit 320, an operation unit 330, etc.

The display unit 310 is, for example, constituted by a liquid crystal display unit or the like. The display unit 310 displays various screens required for operating the stereo camera 1000, a live view image provided for photographing, a taken image of a subject, etc. In this embodiment, a taken image of a subject, a 3D model, etc. are displayed based on image signals (RGB signals) or the like supplied from the image output unit 240.

The external interface unit 320 is, for example, constituted by a USB (Universal Serial Bus) connector, a video output terminal, etc. The external interface unit 320 supplies image data etc. to an external computer apparatus or an external monitor unit.

The operation unit 330 is constituted by various buttons etc. built on the outer surface of the stereo camera 1000. The operation unit 330 generates an input signal in accordance with a user's operation on the stereo camera 1000, and supplies the input signal to the controller 210. For example, assume that the operation unit 330 includes the shutter button 331 for giving an instruction of shutter operation, the operation button 332 for specifying an operation mode etc. of the stereo camera 1000 or setting various functions, and the power button 333.

The stroboscopic light emission unit 400 is, for example, constituted by a xenon lamp (xenon flash). The stroboscopic light emission unit 400 irradiates the subject with flash under the control of the controller 210.

The stereo camera 1000 does not have to have the whole configuration shown in FIG. 2, but may have another configuration than the configuration shown in FIG. 2.

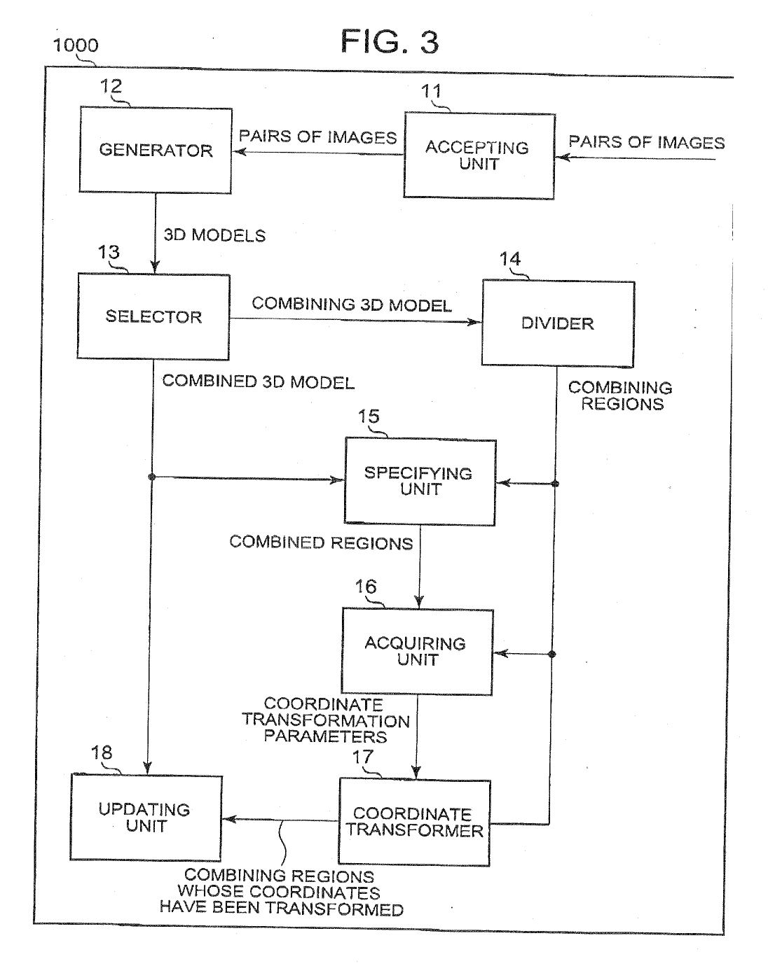

Here, of the operations of the stereo camera 1000, an operation relating to 3D modeling will be described with reference to FIG. 3.

FIG. 3 is a block diagram showing a configuration of a main portion of the stereo camera 1000, that is, a configuration for implementing the operation relating to 3D modeling.

As shown in FIG. 3, the stereo camera 1000 has an accepting unit 11, a generator 12, a selector 13, a divider 14, a specifying unit 15, an acquiring unit 16, a coordinate transformer 17 and an updating unit 18. These units are, for example, constituted by the controller 210.

The accepting unit 11 accepts an input of a plurality of pairs of images obtained by taking images of a subject at different angles in a plurality of shots by use of the stereo camera 1000.

The generator 12 generates a plurality of 3D models of the subject based on the accepted pairs of images, respectively.

The selector 13 selects, from the generated 3D models, a combined 3D model and a combining 3D model which should be combined with the combined 3D model.

The divider 14 divides the selected combining 3D model into a plurality of combining regions.

The specifying unit 15 specifies a plurality of combined regions of the combined 3D model each corresponding to one of the combining regions.

The acquiring unit 16 acquires a plurality of sets of coordinate transformation parameters for superimposing the combining regions on the combined regions corresponding thereto, respectively.

The coordinate transformer 17 transforms the coordinates of the combining regions based on the acquired coordinate transformation parameters respectively.

The updating unit 18 combines the combining regions, whose coordinates have been transformed by the coordinate transformer 17, with the specified combined regions, so as to update the combined 3D model.

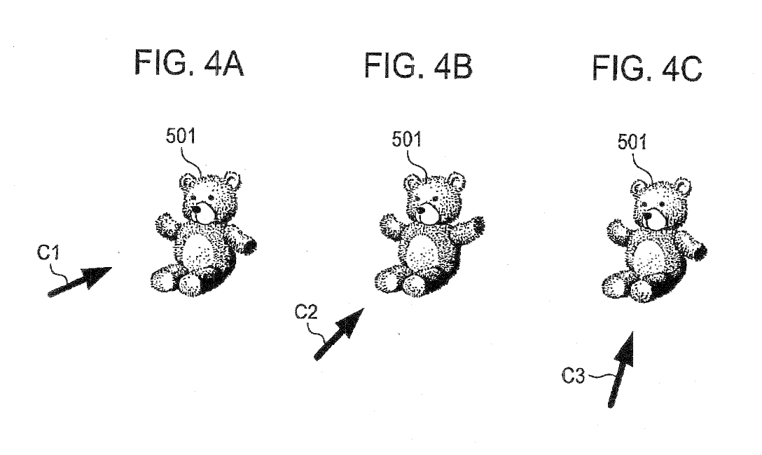

Next, the state where images of a subject are taken will be described with reference to FIGS. 4A to 4C.

The stereo camera 1000 generates a combining 3D model based on a pair of images of a subject obtained by imaging the subject in every shot in which the images are taken. The stereo camera 1000 combines the generated combining 3D model with a combined 3D model. Here, the subject is imaged from different angles in every shot.

In this embodiment, assume that a subject 501 is imaged from a camera position C1 shown in FIG. 4A in a first shot, imaged from a camera position C2 shown in FIG. 4B in a second shot, and imaged from a camera position C3 shown in FIG. 4C in a third shot. Here, assume that the left arm of the subject 501 which is illustrated as a stuffed bear is not lifted in the first shot and the third shot, while the left arm of the subject 501 is lifted in the second shot. In this manner, the stereo camera 1000 can generate a 3D model of the subject 501 which may partially move during shots.

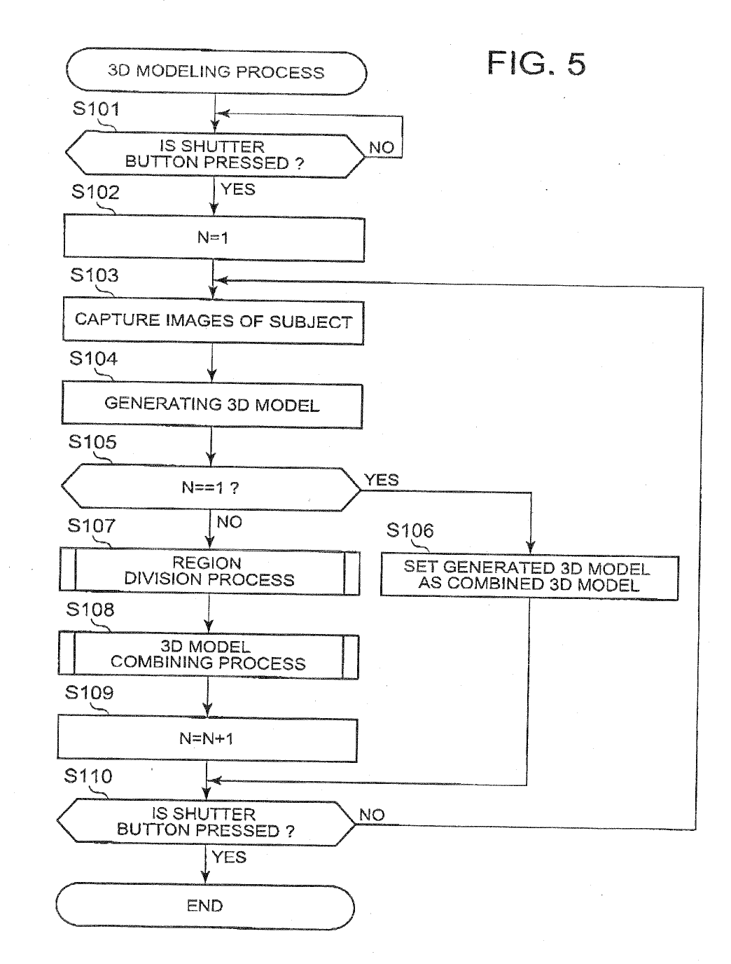

Next, a 3D modeling process executed by the stereo camera 1000 will be described with reference to the flow chart shown in FIG. 5. When the operation mode of the stereo camera 1000 is set as a 3D modeling mode by the operation of the operation button 332 or the like, the stereo camera 1000 executes the 3D modeling process shown in FIG. 5.

First, the controller 210 determines whether the shutter button 331 is pressed or not (Step S101). When concluding that the shutter button 331 is not pressed (NO in Step S101), the controller 210 executes the processing of Step S101 again. On the other hand, when concluding that the shutter button 331 is pressed (YES in Step S101), the controller 210 initializes a shot number counter N to 1 (Step S102). The shot number counter N is, for example, stored in the storage unit 250.

When finishing the processing of Step S102, the controller 210 takes images of the subject 501 (Step S103). When the controller 210 takes images of the subject 501, two parallel coordinate images (paired images) are obtained. The obtained paired images are, for example, stored in the image memory 230.

When finishing the processing of Step S103, the controller 210 generates a 3D model based on the paired images stored in the image memory 230 (Step S104). The 3D model (3D information) is, for example, obtained from the paired images using the following three Expressions (1) to (3). Information expressing the generated 3D model is, for example, stored in the storage unit 250. The details of the method for obtaining 3D information from paired images are, for example, disclosed in Non-Patent Document, Digital Image Processing, CG-ARTS Society, published on Mar. 1, 2006.

X=(b*u)/(u−u′) (1)

Y=(b*v)/(u−u′) (2)

Z=(b*f)/(u−u′) (3)

Here, b designates a distance between the optical devices 110A and 110B, which is referred to as “base length”. (u, v) designates coordinates on an image of the subject 501 taken by the optical device 110A, and (u′, v′) designates coordinates on an image of the subject 501 taken by the optical device 110B. The difference (u−u′) in Expressions (1) to (3) designates a difference in coordinates of the subject 501 between the two images of the same subject 501 taken by the optical devices 110A and 110B respectively. The difference is referred to as “parallax”. f designates a focal length of the optical device 110A. As described previously, the optical devices 110A and 110B have the same configuration, and have the same focal length f.

When finishing the processing of Step S104, the controller 210 determines whether the shot number counter N is 1 or not (Step S105). Here, the fact that the shot number count N is 1 means that it is just after the first shot. When concluding that the shot number counter N is 1 (YES in Step S105), the controller 210 sets the 3D model generated in Step S104 as the combined 3D model (Step S106). Here, the combined 3D model is a 3D model with which the combining 3D model will be combined. That is, the combined 3D model is a 3D model serving as a base of combination.

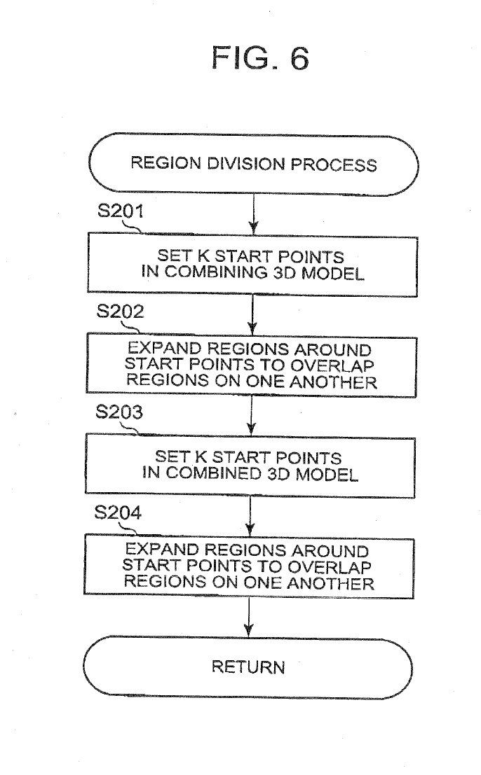

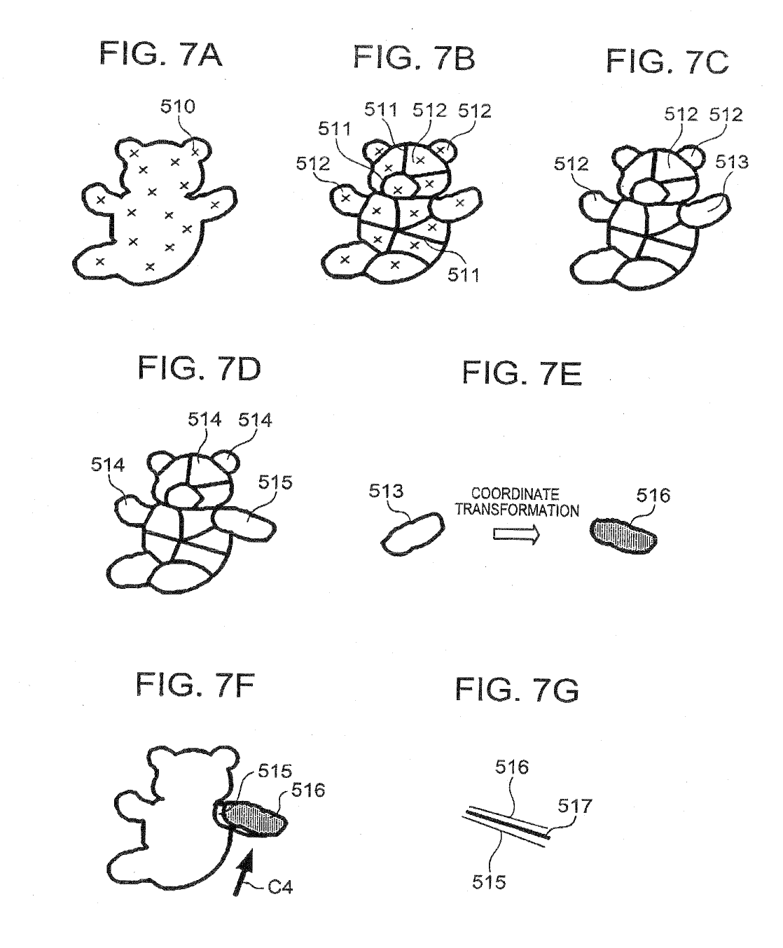

On the contrary, when the controller 210 concludes that the shot number counter N is not 1, that is, it is not just after the first shot (NO in Step S105), the controller 210 executes a region division process (Step S107). The region division process will be described in detail with reference to FIG. 6 and FIGS. 7A to 7D. FIG. 6 is a flow chart showing the region division process of Step S107.

First, the controller 210 sets K start points in the combining 3D model (Step S201). In order to facilitate understanding, the embodiment shows an example in which the combining 3D model is converted into a combining 2D model and divided into regions. That is, in Step S201, K start points 510 are set substantially uniformly on a two-dimensionalized combining 3D model projected on a predetermined plane of projection when the combining 3D model is projected on the plane of projection. The K start points 510 may be set in the subject 501 on one of paired images taken by a shot. FIG. 7A shows an image where the K start points 510 are set on the two-dimensionalized combining 3D model.

When finishing the processing of Step S201, the controller 210 expands regions around the start points 510 till the regions overlap on one another (Step S202). For example, the regions around the start points 510 are expanded at the same speed till the regions overlap on one another. Here, the expansion of the regions is stopped in places where a normal (polygon normal) of a surface of a polygon on a 3D space of the combining 3D model changes suddenly. For example, a base portion of an arm in the combining 3D model, or the like, becomes a border line (border plane in the 3D space) between corresponding regions. FIG. 7B shows a state where the two-dimensionalized combining 3D model has been divided into regions according to such a rule. FIG. 7B shows a state where the two-dimensionalized combining 3D model has been divided into a plurality of small regions (hereinafter referred to as “combining regions”) 512 by border lines 511. FIG. 7C shows the two-dimensionalized combining 3D model which has been divided into the combining regions 512 and from which the start points 510 have been removed. The combining 3D model in the 3D space may be divided into regions directly. In this case, K start points are directly set in the combining 3D model in the 3D space, and regions around the start points are expanded to overlap on one another. The combining 3D model is divided by border planes obtained by the regions expanded around the start points respectively.

When finishing the processing of Step S202, the controller 210 sets the K start points in the combined 3D model (Step S203). When finishing the processing of Step S203, the controller 210 expands regions around the start points 510 in the two-dimensionalized combined 3D model till the regions overlap on one another (Step S204). The method for dividing the two-dimensionalized combined 3D-model into a plurality of small regions (hereinafter referred to as “combined regions”) 514 is similar to the method for dividing the two-dimensionalized combining 3D model into the combining regions 512. When finishing the processing of Step S204, the controller 210 completes the region division process.

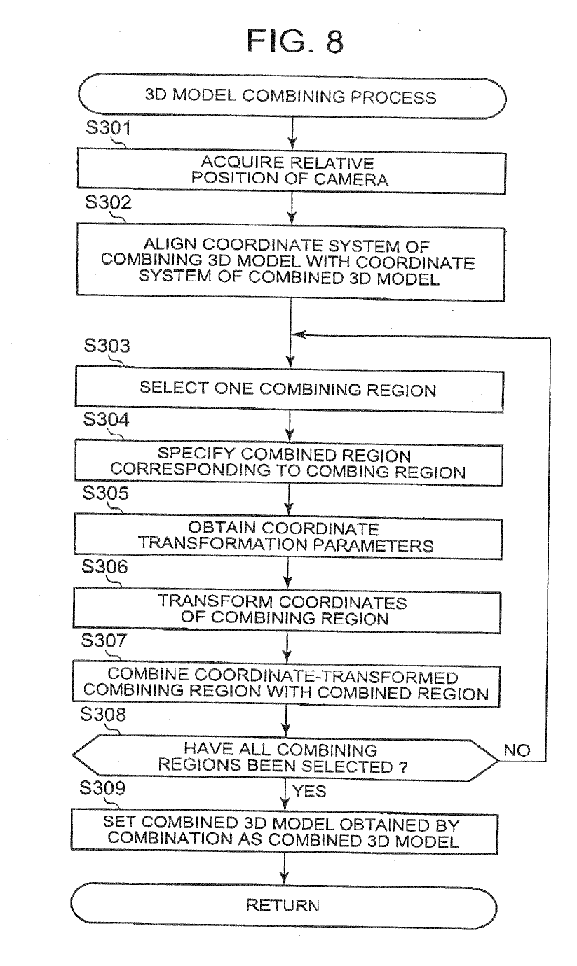

When finishing the processing of Step S107, the controller 210 executes a 3D model combining process (Step S108). The 3D model combining process will be described in detail with reference to the flow chart shown in FIG. 8.

First, the controller 210 acquires the relative position of the stereo camera 1000 (Step S301). Specifically, the relative position of a camera position in a current shot obtaining paired images behind the combining 3D model to be combined this time, to a camera position C1 in the first shot is estimated based on the combined 3D model and the combining 3D model. Here, assume that a cameral position C2 is estimated relatively to the camera position C1. That is, the combined 3D model is a 3D model generated from paired images obtained in a shot from the camera position C1, and the combining 3D model is a 3D model generated from paired images obtained in a shot from the camera position C2.

The controller 210 estimates the relative camera position based on a difference in coordinates of each feature point on the 3D space, which feature point is shared between the combined 3D model and the combining 3D model. In this embodiment, first, the controller 210 takes a correspondence in each feature point on a 2D space between the combined 3D model which has been projected and converted onto the 2D space in view from the camera position C1 and the combining 3D model which has been projected and converted onto the 2D space in view from the camera position C2 (for example, by a SHFT method or the like). Further, the controller 210 improves the accuracy of the correspondence in each feature point based on 3D information obtained by stereo image modeling. Based on the relationship of correspondences in the feature points, the controller 210 calculates the relative position of the camera position C2 to the camera position C1. In this embodiment, the left arm of the subject 501 is not lifted in the first shot, but the left arm of the subject 501 is moved and lifted in the second shot. Therefore, strictly speaking, the coordinates of the subject 501 in the first shot do not coincide with the coordinates of the subject 501 in the second shot perfectly. However, the left arm is regarded as noise. Thus, the relative camera position can be roughly estimated.

When finishing the processing of Step S301, the controller 210 aligns the coordinate system of the combining 3D model with the coordinate system of the combined 3D model based on the relative camera position obtained in Step S301 (Step S302).

When finishing the processing of Step S302, the controller 210 selects one combining region 512 from the combining regions 512 of the two-dimensionalized combining 3D model (Step S303). Here, description will be made on the assumption that a combining region 513 is selected from the combining regions 512.

When finishing the processing of Step S303, the controller 210 specifies a combined region 514 corresponding to the combining region 513 selected in Step S303 (Step S304). That is, the controller 210 specifies, of the regions constituting the combined 3D model in the 3D space, a region in the neighborhood of a region on the 3D space corresponding to the selected combining region 513. The neighborhood can be calculated because the coordinate system of the combining 3D model is aligned with the coordinate system of the combined 3D model in Step S302. Here, assume that a combined region 515 corresponds to the combining region 513.

When finishing the processing of Step S304, the controller 210 obtains a set of coordinate transformation parameters for aligning the combining region 513 selected in Step S303 with the combined region 515 specified in Step S304 (Step S305). The set of coordinate transformation parameters are expressed by a 4×4 matrix H. Coordinates W′ of the combining region 513 are transformed into coordinates W of the combined region 515 by the following Expression (4).

kW=HW′ (4)

Here, k designates a given value, and the coordinates W and W′ have the same number of dimensions. Accordingly, the dimensions of the matrix H are expanded and 1 is stored in the fourth dimension. The matrix H is expressed by the following Expression (5) using a 3×3 rotation matrix R and a 3×1 translation vector T.

$$H = ( \begin{matrix}R ( 1 , 1 ) & R ( 1 , 2 ) & R ( 1 , 3 ) & T ( 1 ) \\ R ( 2 , 1 ) & R ( 2 , 2 ) & R ( 2 , 3 ) & T ( 2 ) \\ R ( 3 , 1 ) & R ( 3 , 2 ) & R ( 3 , 3 ) & T ( 3 ) \\ 0 & 0 & 0 & 1\end{matrix} ) \qquad ( 5 )$$

Assume that the matrix H of coordinate transformer parameters can be obtained when corresponding points satisfying the matrix H are found out between the combining region 513 and the combined region 515 and the number of the corresponding points is not smaller than a threshold value. When a plurality of combined regions 514 corresponding to the combining region 513 are specified in Step S304, the controller 210 extracts candidates of feature points from each of the specified combined regions 514 and narrows corresponding points using RANSAC or the like. Thus, one combined region 515 can be specified.

When finishing the processing of Step S305, the controller 210 transforms the coordinates of the combining region 513 selected in Step S303 using the coordinate transformer parameter matrix H obtained in Step S305 (Step S306).

For example, assume that the combining region 513 in FIG. 7C is selected in Step S303, and the combined region 515 in FIG. 7D is specified in Step S304. In this case, as shown in FIG. 7E, the combining region 513 is transformed as a combining region 516 by coordinate transformation in Step S306.

When finishing the processing of Step S306, the controller 210 combines the coordinate-transformed combining region 516 with the combined region 515 (Step S307). Although the combining region 516 may be simply superimposed on the combined region 515, this embodiment will be described in the example in which a smoothing process is executed on a border portion between the combining region 516 and the combined region 515.

In the smoothing process, regions essentially overlapping on each other (or regions including feature points used for obtaining the transformation parameter matrix H) are arranged so that a plane expressing the average between the regions is formed as a modeling surface of a new 3D model. FIG. 7F shows a state where the combining region 516 has been superimposed on the combined region 515. FIG. 7G shows a state of a border plane on the 3D space viewed from the direction of an arrow C4 in FIG. 7F. FIG. 7G shows a new modeling surface 517 obtained by taking an average of the Euclidean distance between the combined region 515 and the combining region 516.

When finishing the processing of Step S307, the controller 210 determines whether all the combining regions 512 have been selected or not (Step S308). When concluding that there is a combining region 512 which has not yet been selected (NO in Step S308), the controller 210 returns to the processing of Step S303. On the contrary, when concluding that all the combining regions 512 have been selected (YES in Step S308), the controller 210 sets the combined 3D model obtained by combination as a combined 3D model (Step S309), and then terminates the 3D model combining process.

When finishing the processing of Step S108, the controller 210 increases the value of the shot number counter N by 1 (Step S109).

When finishing the processing of Step S106 or Step S109, the controller 210 determines whether the shutter button 331 is pressed or not (Step S110). When concluding that the shutter button 331 is pressed (YES in Step S110), the controller completes the 3D modeling process. On the contrary, when concluding that the shutter button 331 is not pressed (NO in Step S110), the controller 210 returns to the processing of Step S103.

With the stereo camera 1000 according to this embodiment, a 3D model of a subject can be generated even if a part of the subject is moving. This embodiment is effective for the case where the specified part of the subject moves as one. The reason can be considered that region division is performed so that the part moving as one belongs to one and the same region. That is, according to this embodiment, region division is performed so that a part connecting with the part moving as one, such as a joint of a human or an animal, a joint portion of a stuffed toy, or the like, serves as a border for the region division. Coordinate transformation is performed on every divided region. Accordingly, even if a part of regions moves as one, the part of regions can be combined in the same manner as in the case where the moving part would not move.

### Second Embodiment

The first embodiment has showed an example in which a two-dimensionalized combining 3D model is divided into combining regions 512 and a two-dimensionalized combined 3D model is divided into combined regions 514. That is, the first embodiment has showed an example in which a region corresponding to one of the combining regions 512 is selected from the combined regions 514. However, the two-dimensionalized combined 3D model does not have to be divided into the combined regions 514.

In this case, the region division process shown in FIG. 6 is completed when the processing of Step S201 and Step S202 is executed. That is, in the region division process, the processing of Step S203 and Step S204 is not executed. In Step S304 in the 3D model combining process shown in FIG. 8, a region corresponding to the combining region 513 selected in Step S303 (or a region close to the combining region 513) is specified directly from the two-dimensionalized combined 3D model. The region corresponding to the combining region 513 is, for example, obtained by comparison between feature points in the combining region 513 and feature points in the two-dimensionalized combined 3D model. The coordinate transformation parameter matrix H is also obtained in the same manner by comparison between feature points in the combining region 513 and feature points in the two-dimensionalized combined 3D model. The configuration and operation of the stereo camera 1000 according to this embodiment other than the aforementioned operation are similar to those in the first embodiment.

According to the stereo camera 1000 in this embodiment, the same effect as that in the first embodiment can be obtained without dividing the two-dimensionalized combined 3D model into regions. It is therefore possible to save the processing time spent for the region division.

### (Modifications)

The invention is not limited to the aforementioned embodiments.

The invention is also applicable to an apparatus (such as a personal computer) having no imaging device. In this case, 3D models are combined based on a plurality of pairs of images prepared in advance. Of the pairs of images, a pair of images where a subject looks best may be assigned as a reference pair of images (key frame).

The 3D modeling apparatus according to the invention may be implemented with a normal computer system without using any dedicated system. For example, a program for executing the aforementioned operations may be stored and distributed in the form of a computer-readable recording medium such as a flexible disk, a CD-ROM (Compact Disk Read-Only Memory), a DVD (Digital Versatile Disk) or an MO (Magneto Optical Disk), and installed in a computer system, so as to arrange a 3D modeling apparatus for executing the aforementioned processes.

Further, the program stored in a disk unit or the like belonging to a server apparatus on the Internet may be, for example, superposed on a carrier wave so as to be downloaded into a computer.

While the present invention has been shown and described with reference to certain exemplary embodiments thereof, it will be understood by those skilled in the art that various changes in form and details may be made therein without departing from the spirit and scope of the invention as defined by the appended claims. It is aimed, therefore, to cover in the appended claim all such changes and modifications as fall within the true spirit and scope of the present invention.

What is claimed is:

1. A 3D modeling apparatus comprising:
an accepting unit configured to accept a plurality of sets of images that are obtained by capturing a subject at different angles using a stereo camera;
a generator configured to generate a plurality of 3D models of the subject based on the sets of images, wherein each of the 3D models corresponds to one of the sets of images;
a selector configured to select a first 3D model and a second 3D model from the plurality of 3D models, wherein the second 3D model is to be superimposed on the first 3D model;
a divider configured to divide the second 3D model into a plurality of second regions;
a specifying unit configured to specify a plurality of first regions in the first 3D model, wherein each of the first regions corresponds to one of the second regions;
an acquiring unit configured to acquire a plurality of coordinate transformation parameters for superimposing each of the second regions on the corresponding first region;
a transformation unit configured to transform coordinates of the second regions based on the coordinate transformation parameters; and
an updating unit configured to superimpose the second regions having the transformed coordinates on the first regions so as to update the first 3D model.

2. The apparatus of claim 1, wherein after the updating unit updates the first 3D model, the selector selects the updated first 3D model as a new first 3D model, and then the selector selects a new second 3D model from the plurality of 3D models, wherein the new second 3D model is to be superimposed on the updated first 3D model.

3. The apparatus of claim 1,
wherein the divider is configured to divide the first 3D model into a plurality of regions, and
the specifying unit is configured to specify the plurality of first regions each corresponding to one of the second regions, from the plurality of regions of the first 3D model.

4. The apparatus of claim 1,
wherein the updating unit is configured to update the first 3D model such that each of Euclidean distances between surfaces of the updated first 3D model and border planes among the second regions having the transformed coordinates coincides with a corresponding one of Euclidean distances between the surfaces of the updated first 3D model and border planes among the first regions.

5. The apparatus of claims 1,
wherein the divider is configured to:
(i) set a plurality of start points in the second model;
(ii) enlarge a plurality of regions around the start points such that the adjacent enlarged regions overlaps with each other; and
(iii) set the enlarged regions around the start points as the plurality of second regions.

6. The apparatus of claim 1,
wherein the specifying unit is configured to specify the plurality of first regions in the first 3D model, based on relationship between feature points included in the second regions and feature points included in the first 3D model.

7. A 3D modeling method comprising:
(a) capturing a subject at different angles using a stereo camera so as to obtain a plurality of sets of images;
(b) generating a plurality of 3D models of the subject based on the sets of images, wherein each of the 3D models corresponds to one of the sets of images;
(c) selecting a first 3D model and a second 3D model from the plurality of 3D models, wherein the second 3D model is to be superimposed on the first 3D model;
(d) dividing the second 3D model into a plurality of second regions;
(e) specifying a plurality of first regions in the first 3D model, wherein each of the first regions corresponds to one of the second regions;
(f) acquiring a plurality of coordinate transformation parameters for superimposing each of the second regions on the corresponding first region;
(g) transforming coordinates of the second regions based on the coordinate transformation parameters; and
(h) superimposing the second regions having the transformed coordinates on the first regions so as to update the first 3D model.

8. A computer-readable medium storing a program for causing the computer to perform operations comprising:
(a) capturing a subject at different angles using a stereo camera so as to obtain a plurality of sets of images;
(b) generating a plurality of 3D models of the subject based on the sets of images, wherein each of the 3D models corresponds to one of the sets of images;
(c) selecting a first 3D model and a second 3D model from the plurality of 3D models, wherein the second 3D model is to be superimposed on the first 3D model;
(d) dividing the second 3D model into a plurality of second regions;
(e) specifying a plurality of first regions in the first 3D model, wherein each of the first regions corresponds to one of the second regions;
(f) acquiring a plurality of coordinate transformation parameters for superimposing each of the second regions on the corresponding first region;
(g) transforming coordinates of the second regions based on the coordinate transformation parameters; and
(h) superimposing the second regions having the transformed coordinates on the first regions so as to update the first 3D model.
